(19) United States
(12) Patent Application Publication
(10) Pub. No.: US 2008/0026695 A1
(43) Pub. Date: Jan. 31, 2008

(54) Method and system for transmitting voice data by using wireless LAN and bluetooth

(76) Inventors: Hyo Jin Choi, Kwangmyung City (KR); Jin Hwan Jeon, Seoul (KR); Dae Hong Kim, Seoul (KR); Kyeongho Lee, Seoul (KR); Sang Min Shim, Seoul (KR); Won Hoeh Song, Seoul (KR)

Correspondence Address: THE FLESHNER GROUP, PLLC, P.O. BOX 1397, ASHBURN, VA, 20146-9998, US

(21) Appl. No.: 11/878,938

(22) Filed: Jul. 27, 2007

(30) Foreign Application Priority Data
Jul. 28, 2006 (KR) 10-2006-0071217

(51) Int. Cl. H04B 7/00; H04Q 7/20

(52) U.S. Cl. 455/41.3; 370/338

(57) ABSTRACT

Embodiments of methods and systems of the application can transmit data (e.g., voice) using a wireless LAN and a Bluetooth. One system embodiment can include a terminal device, an AP (access point) for communicating with the terminal device according to a first (e.g., wireless LAN) protocol by using a first frequency band among multiple frequency bands of a prescribed frequency band (e.g., ISM frequency band) and a headset for communicating with the terminal device according to a second (e.g., Bluetooth) protocol by using at least one frequency band of remaining frequency bands by excepting the first frequency band.

### FIELD OF THE INVENTION

The application relates to methods and systems for data transmission that allows a headset to transmit/receive data to/from an AP (access point), which can correspond to a base station of the wireless LAN or the like), and a terminal device for use therein.

### BACKGROUND OF THE INVENTION

Recently, with a rapid spread of a wireless LAN, a telephone call using the wireless LAN is being tried. The telephone call using the wireless LAN is referred to as VoWLAN (voice over wireless LAN). Moreover, as the Bluetooth technique has been spread, it is being increased to listen music or to speak to a person over the telephone by using a headset wirelessly connected to a terminal device such as a notebook computer, a cellular phone or the like.

As described above, the related art has various disadvantages. During a telephone call, the terminal device is connected to a network through the wireless LAN while the terminal device is connected with the headset by using the Bluetooth. A conflict can occur since the wireless LAN may use the same frequency band as the Bluetooth. For example, since both of the wireless LAN and the Bluetooth use an unlicensed 2.4 GHz ISM (industrial, scientific and medical) frequency band, the terminal device cannot communicate with the headset through the use of the Bluetooth when a station, e.g., the terminal device, is communicating with the AP by using the wireless LAN. Further, a communication between the terminal device and the AP cannot also be carried out through the wireless LAN when the terminal device is communicating with the headset by using the Bluetooth. In order to perform a real-time voice telephone call, however, a process of transmitting voice data between the terminal device and the AP and a process of transmitting voice data between the terminal device and the headset have to be repeated. Therefore, systems and methods are needed to manage resources efficiently.

### SUMMARY OF THE INVENTION

An object of embodiments of the application is to solve at least the above problems and/or disadvantages in the related art or to provide at least the advantages described herein in whole or in part.

Another object of embodiments of the application is to provide data transmission methods and data transmission systems that allow a headset wirelessly coupled with a terminal device to transmit data (e.g., voice data) to an AP and to receive data from the AP via the terminal device by managing resources of a first communication device or protocol (e.g., wireless LAN) and a second communication device or protocol (e.g., Bluetooth) using or sharing a frequency band.

To achieve objects of embodiments of the application in whole or in part, there is provided a system that can include a terminal device, an access point (AP) to transmit voice data or receive voice data from the terminal device according to a wireless LAN protocol and a headset to transmit voice data to or receive voice data from the terminal device according to a Bluetooth protocol, the terminal device to communicate with the AP during a first period, the terminal device to communicate with the headset during a second period that does not coincide with the first period, the AP to communicate with the terminal device and another terminal device by using a first frequency band among at least three frequency bands of industrial, scientific and medical (ISM) frequency band, the headset to communicate with the terminal device by using at least one remaining frequency band from the at least three frequency bands.

To further achieve objects of embodiments of the application in whole in part, there is provided a voice data transmission method in a system including a terminal device, an access point (AP) to communicate with the terminal device according to a wireless LAN protocol, and a headset to communicate with the terminal device according to a Bluetooth protocol, the method can include communicating with the AP by using a first frequency band among three frequency bands of an industrial, scientific and medical (ISM) frequency band by the terminal device, broadcasting a clear to send (CTS) packet using at least one frequency band of a second frequency band and a third frequency band from said three frequency bands by the terminal device and communicating with the headset by using the at least one frequency band by the terminal device.

To achieve objects of embodiments of the application in whole or in part, there is provided a terminal device including: a wireless LAN baseband processor, a Bluetooth baseband processor to transmit/receive data to/from the wireless LAN baseband processor, an RF circuit coupled to the wireless LAN baseband processor and the Bluetooth baseband processor, an antenna connected to the RF circuit and a resource scheduler to control the RF circuit so that the wireless LAN baseband processor performs a communication by using a first frequency band among a plurality of frequency bands of industrial, scientific, and medical (ISM) frequency band, and to control the RF circuit so that the Bluetooth baseband processor conducts a communication by using at least a second frequency band or a third frequency band of said plurality of frequency bands.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

Embodiments will be described in detail with reference to the following drawings in which like reference numerals refer to like elements and wherein:

FIG. 1 is a diagram that shows a voice data transmission system in accordance with an embodiment of the application;

FIG. 2 is a diagram that shows a voice data transmission method in accordance with an embodiment of the application; and

FIG. 3 is a block diagram that shows an example of a terminal device shown in FIG. 1.

### DETAILED DESCRIPTION OF THE PREFERRED EMBODIMENTS

Embodiments according to the application will be described with reference to the accompanying drawings. Such embodiments are exemplary and not to be construed as limiting. Many alternatives, modifications, and variations will be apparent to those skilled in the art.

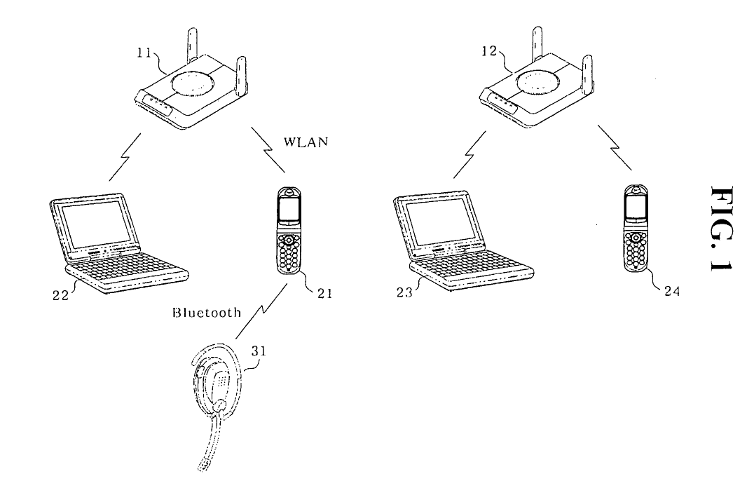

FIG. 1 is a diagram that shows a voice data transmission system in accordance with an embodiment of the application. As shown in FIG. 1, the voice data transmission system can include a first AP (access point) 11, a first terminal device 21 and a headset 31. A second AP 12 and second to fourth terminal devices 22 to 24 are shown to illustrate exemplary interferences with the voice data transmission system 11, 21 and 31.

The first AP 11 can correspond to a base station of the wireless LAN and communicate with the first terminal device 21 according to a wireless LAN protocol to transmit downlink voice data to the first terminal device 21 and to receive uplink voice data from the first terminal device 21. Since the unlicensed 2.4 GHz ISM frequency band can be divided into three frequency bands, the first AP 11 can communicate with the first and the second terminal devices 21 and 22 by using one frequency band (e.g., a first frequency band) among the three divided frequency bands of the unlicensed ISM frequency band. To restrain interferences with the first AP 11, the second AP 12 can communicate with the third and the fourth terminal devices 23 and 24 by using a different frequency band such as one of a second frequency band and a third frequency band not used by the first AP 11.

The first terminal device 21 carries out a communication with the first AP 11 according to the wireless LAN protocol and performs a communication with the headset 31 according to a Bluetooth protocol. However, embodiments according to the application are not intended limited by such an exemplary disclosure, for example, other protocols may be supported. The first terminal device 21 is an apparatus capable of performing a wireless LAN communication and a Bluetooth communication, and for example, it may be a notebook computer, a cellular phone, a PDA (personal digital assistant) or the like.

The headset 31 can include a speaker and a microphone to enable a voice telephone conversation and perform the Bluetooth communication with the first terminal device 21. Thus, the headset 20 can transmit uplink voice data to the first terminal device 21 and to receive downlink voice data from the first terminal device 21.

In accordance with embodiments of a voice data transmission system or methods of the application, a period during which the first terminal device 21 communicates with the first AP 11 preferably does not coincide with a period during which the first terminal device 21 communicates with the headset 31. For example, when the first terminal device 21 is communicating with the first AP 11, the first terminal device 21 does not perform a communication with the headset 31. Further, when the first terminal device 21 is communicating with the headset 31, the first terminal device 21 does not perform a communication with the first AP 11. Such a system can enable the first terminal device 21 to perform both of a communication based on a Bluetooth standard and a communication according to a wireless LAN standard by using one RF circuit and one antenna.

In accordance with one embodiment of the voice data transmission system, a frequency band for use in a communication between the first terminal device 21 and the first AP 11 can be different from that for use in a communication between the first terminal device 21 and the headset 31. For example, if the first AP 11 conducts a communication with the first and the second terminal devices 21 and 22 through the use of the first band of the ISM frequency band, the first terminal device 21 can perform a Bluetooth communication with the headset 31 by using a whole part or a part of the remaining frequency bands, e.g., the second and the third frequency bands of the ISM frequency band. In this example, a frequency hopping of the Bluetooth is constrained to be carried out within the second and the third frequency bands of the ISM frequency band. If the frequency bands are assigned by using above-described methods, an occurrence of interference is reduced or suppressed and, therefore, a transmission/reception can be performed smoothly. Further, if the first terminal device 21 conducts a communication with the headset 31 through the use of the second and the third frequency bands, there is no possibility that interference occurs, thereby preventing an error caused by the interference. In contrast, if the first AP communicates with the first and second terminal devices 21 and 22 through the first frequency band of the ISM frequency band, and the first terminal device 21 communicates with the headset 31 through the first frequency band, interference may occur since the second terminal device 22 can also use the first frequency band to communicate with the AP 11 when the first terminal device 21 is communicating with the headset 31.

In general, in order to reduce or prevent interference with the first AP 11, the second AP 12 adjacent to the first AP 11 can use frequency bands of the ISM frequency band except for the first frequency band (e.g., the second frequency band) to communicate with the third and the fourth terminal devices 23 and 24. Accordingly, a communication between the second AP 12 and the third and the fourth terminal devices 23 and 24 may interfere with a communication between the first terminal device 21 and the headset 31 using the second and the third frequency bands, and it is preferably or necessary to prevent such interferences in advance. Therefore, it is preferable that the first terminal device 21 broadcasts a CTS (clear to send) packet in a frequency band used in the Bluetooth communication before performing the Bluetooth communication to reduce or prevent the second AP 12 from communicating with the third and the fourth terminal devices 23 and 24 through the use of the same frequency band as that of the Bluetooth communication. If both of the second and the third frequency bands are used in the Bluetooth communication, the terminal device 21 should have to broadcast the CTS packet in both of the second and the third frequency bands. If one of the second and the third frequency bands is employed in the Bluetooth communication, the CTS packet will be broadcasted only in the corresponding frequency band. The CTS packet is a packet for requesting another device and another base station to interrupt a wireless communication during a predetermined period according to the wireless LAN protocol. If the CTS packet is broadcasted like this, interference may not occur and, therefore, the terminal device 21 can communicate with the headset 31 without interference or with reduced interference.

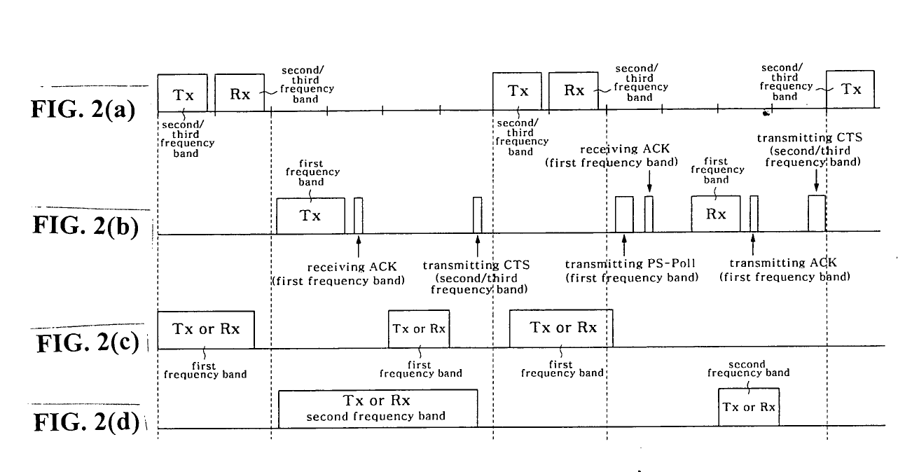

FIGS. 2(a)-2(d) are diagrams for illustrating a voice data transmission method in accordance with an embodiment. The voice data transmission method will be described using the system embodiment of FIG. 1, however method embodiments according to the application are not intended to limited by using such an exemplary system embodiment disclosure.

FIG. 2(a) shows a method for allowing the first terminal device 21 to transmit/receive voice data from/to the headset 31 by using the Bluetooth. FIG. 2(b) illustrates a method for allowing the first terminal device 21 to transmit/receive voice data from/to the first AP 11 by using the wireless LAN. FIG. 2(c) is a diagram for showing a communication between the first AP 11 and the second terminal device 22, and FIG. 2(d) is a diagram for showing a communication between the second AP 12 and the third terminal device 23.

As shown in FIG. 2(a), since the first frequency band can be used in the wireless communication of the first AP 11, the Bluetooth communication between the first terminal device 21 and the headset 31 can use the second and the third frequency bands.

In a first slot, the first terminal device 21 transmits downlink voice data to the headset 31 and, in a second slot, the first terminal device 21 receives uplink voice data from the headset 31. Then, during four slots, the first terminal device 21 does not communicate with the headset 31. Thereafter, the first terminal device 21 can repeat (e.g., a six slot time period) the process of transmitting voice data and receiving voice data and interrupting a transmission/reception. Such a link repeating the transmission and the reception is referred to as SCO (synchronous connection oriented) link. The SCO link is mainly used in a voice communication. Moreover, as shown in FIGS. 2(a)-2(d), an exemplary method for performing a transmission/reception by using 2 slots among 6 slots and not performing a transmission/reception during the remaining 4 slots is referred to as HV3 (high quality voice 3). One reason for using the HV3 is to carry out the wireless LAN communication during an interval (e.g., the four slots) within which the Bluetooth transmission/reception is preferably not performed.

However, embodiments of the application are not intended to be so limited, for example, instead of using the HV3, it is also possible to use HV2 (high quality voice 2) for performing a transmission/reception by using 4 slots among 6 slots and not performing a transmission/reception during the remaining 2 slots. However, since the HV2 has to conduct the wireless LAN communication only during 2 slots, there is a high possibility of being unable to sufficiently perform the wireless LAN communication. Accordingly, it is preferable to use the HV3 method in lieu of the HV2 method.

Further, eSCO (extended SCO) method (not shown) can also be adopted. In case of employing the eSCO method, it is possible to adjust a cycle, a period during which the Bluetooth communication between the first terminal device 21 and the headset 31 is performed and a period during which the Bluetooth communication between the first terminal device 21 and the headset 31 is not performed. For example, in a cycle of 34 slots, a first communication period of 6 slots during which the Bluetooth communication is conducted and a second communication period of 28 slots during which the Bluetooth communication is not conducted can be used. However, embodiments according to the application are not intended to be so limited by such an exemplary disclosure.

Thus, the first terminal device can communicate to the headset downlink in a first time period, and uplink in a second time period and communicate downlink to the first access point in a third time period and uplink in a fourth time period of a periodic communication interval.

Since the first terminal device 21 has to manage a timing for transmitting/receiving voice data, it is preferable that the first terminal device 21 serves as a master while the headset 31 serves as a slave. However, embodiments according to the application are not intended to limited.

As shown in FIG. 2(b), the first terminal device 21 can communicate with the first AP 11 by using the first frequency band. Further, the first terminal device 21 can broadcast the CTS packet in the second and the third frequency bands before performing the Bluetooth communication.

The first terminal device 21 carries out the wireless LAN communication with the first AP 11 during the period (e.g., four slots) within which the Bluetooth communication is not performed. A process of transmitting uplink voice data to the first AP 11 by the first terminal device 21 during the wireless LAN communication can be easily carried out since the first terminal device 21 can control the timing. For example, as shown in FIG. 2(b), the process is enabled by transmitting the uplink voice data to the first AP 11 and receiving ACK (acknowledgement) from the first AP 11 by the first terminal device 21. Of course, since the wireless LAN can avoid a conflict based on CSMA/CA (carrier sense multiple access with collision avoidance), the first terminal device 21 can transmit the uplink voice data to the headset 31 by using a period during which a conflict does not occur in the four slots. In case that the uplink voice data cannot be transmitted during the four slots due to the conflict, it is also possible to maintain a stand-by status and then to transmit voice data during the following 4 slots within which the Bluetooth transmission/reception is not conducted.

Since a period during which the first terminal device 21 receives voice data from the first AP 11 by using the wireless LAN communication is basically determined by the first AP 11, the first terminal device 21 cannot control a timing for receiving voice data through the wireless LAN communication. Accordingly, the first AP 11 transmits downlink voice data to the first terminal device 21 at any time, so that the Bluetooth transmission/reception period of the first terminal device 21 may conflict with the transmission period of the first AP 11. Therefore, it may occur that the downlink voice data cannot be transmitted from the first AP 11 to the first terminal device 21. At this time, the first AP 11 can conduct a re-transmission by lowering a transmission speed, e.g., by increasing a data transmission period in order to transmit voice data safely. However, if the data transmission period is increased, a probability of conflicting with the Bluetooth transmission/reception period will also be increased. Therefore, it becomes more difficult to transmit voice data from the first AP 11 to the first terminal device 21.

In another embodiment, to reduce or prevent such a situation and to control a timing for receiving voice data by the first terminal device 21, it is preferable to make use of a PS-Poll (power save poll) frame. For example, the first terminal device 21 can enter into a PS (power save) mode in order to prevent the first AP 11 from transmitting voice data to the first terminal device 21 at any time. A process of entering into the PS mode is not shown in FIG. 2(b). Thereafter, when the first terminal device 21 wants to receive the downlink voice data from the first AP 11, the first terminal device 21 can send the PS-Poll frame to the first AP 11. The first AP 11 that received the PS-Poll frame can transmit ACK to the first terminal device 21 and then sends downlink voice data of one frame stored in the first AP 11 to the first terminal device 21. Upon receipt of the downlink voice data of one frame, the first terminal device 21 can transmit ACK to the first AP 11. Through such a process, the first terminal device 21 receives voice data from the first AP 11. Since the first terminal device 21 can transmit voice data to the first AP 11 while maintaining the PS mode, it is preferable that the first terminal device 21 maintains the PS mode while transmitting voice data to the first AP 11. That is, it is desirable that the first terminal device 21 enters into the PS mode in advance before performing the voice data transmission.

In another embodiment, the first terminal device 21 can periodically receive a Beacon frame, and only when the Beacon frame indicates that there are data to be transmitted from the first AP 11 to the first terminal device 21, it can transmit the PS-Poll frame to the first AP 11. For example, the first terminal device 21 doesn't have to transmit the PS-Poll frame to the first AP 11 whenever it has an opportunity, and therefore, it is possible to transmit the PS-Poll frame to the first AP 11 only when the previously received Beacon frame indicates that there are data to be transmitted.

Although only an example of performing the wireless LAN transmission within the first four slots during which the Bluetooth transmission/reception is not conducted and executing the wireless LAN reception within the second four slots during which the Bluetooth transmission/reception is not carried out is shown in FIGS. 2(a)-2(d), it is also possible to perform both of a transmission and a reception within four slots during which the Bluetooth transmission/reception is not conducted. However, since the four slots period is very short, i.e., 2.5 ms, it is preferable to perform a transmission and a reception separately.

As shown in FIG. 2(c), the second terminal device 22 can communicate with the first AP 11 by using the first frequency band. As shown in FIG. 2(c), a period during which the second terminal device 22 communicates with the first AP 11 may correspond to a period during which the first terminal device 21 communicates with the headset 31. However, a frequency band (e.g., the first band) used to communicate with the first AP 11 by the second terminal device 22 is preferably different from a frequency band (e.g., the second and the third frequency bands) of the ISM band used to communicate with the headset 31 by the first terminal device 21, so that interference between them may not occur or be reduced.

As shown in FIG. 2(d), the second AP 12 can communicate with the third terminal device 23 by using the second frequency band. Accordingly, interference with the Bluetooth communication using the second and the third frequency bands may occur. However, as shown in FIGS. 2(a)-2(d) the drawing, the second AP 12 and the third terminal device 23 do not perform a communication with reference to the CTS packet, to thereby prevent or reduce this interference.

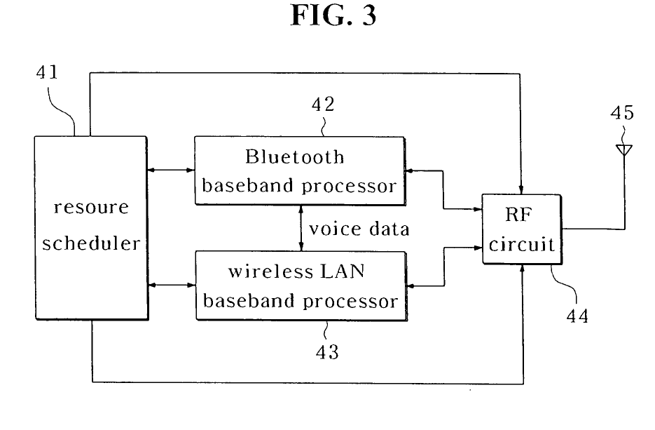

FIG. 3 provides a block diagram showing an example of the first terminal device. The exemplary first terminal device shown in FIG. 3 can be used as the first terminal device 21, however, embodiments of the application are not intended to be so limited. Referring to FIG. 3, the first terminal device (e.g., 21) can include a resource scheduler 41, a Bluetooth baseband processor 42, a wireless LAN baseband processor 43, an RF circuit 44 and an antenna 45.

Although two baseband processors 42 and 43 are included therein, the terminal device may employ the single RF circuit 44 and antenna 45. If a Bluetooth baseband processor shares the same RF circuit and antenna with a wireless LAN baseband processor, it will be more difficult that a communication using the Bluetooth coexists with a communication using the wireless LAN. One reason the terminal device can employ the single RF circuit 44 and antenna 45 is the Bluetooth and the wireless LAN can use the same frequency band. However, embodiments according to the application are not intended to limited by such an exemplary disclosure. For example, it is also possible that the Bluetooth baseband processor 42 and the wireless LAN baseband processor 43 can be coupled to separate RF circuits, respectively.

The Bluetooth baseband processor 42 can transmit/receive voice data to/from the wireless LAN baseband processor 43. For example, uplink voice data transmitted from a headset (e.g., the headset 31) to the Bluetooth baseband processor 42 via the antenna 45 and the RF circuit 44 is sent to the wireless LAN baseband processor 43 and then the wireless LAN baseband processor 43 transmits the sent uplink voice data to a network (e.g., the AP 11 through the RF circuit 44 and the antenna 45). Further, downlink voice data transmitted from the AP 11 to the wireless LAN baseband processor 43 via the antenna 45 and the RF circuit 44 is sent to the Bluetooth baseband processor 42 and then the Bluetooth baseband processor 42 transmits the sent downlink voice data to a headset (e.g., the headset 31 through the RF circuit 44 and the antenna 45).

The terminal device can include a memory. For example, a buffer memory can be placed between the Bluetooth baseband processor 42 and the wireless LAN baseband processor 43 so that the sent voice data can be stored temporarily before output.

The resource scheduler 41 can control the RF circuit 44 so that the wireless LAN baseband processor 43 performs a communication by using one frequency band, e.g., the first frequency band, among a plurality of (e.g., three) frequency bands of the exemplary ISM frequency band, and control the RF circuit 44 so that the Bluetooth baseband processor 42 conducts a communication by using at least one frequency band of the remaining frequency bands (e.g., the second and the third frequency bands), by excepting the previously selected (e.g., first) frequency band from the three frequency bands of the ISM frequency band. For example, a local oscillator (not shown) of the RF circuit 44 can generate both a frequency for use in the Bluetooth communication and a frequency for use in the wireless LAN communication of the ISM frequency band. The resource scheduler 41 can control the local oscillator to generate a desired frequency.

Further, the resource scheduler 41 can control the wireless LAN baseband processor 43 and the RF circuit 44 such that the wireless LAN baseband processor 43 broadcasts the CTS packet in at least one frequency band before the Bluetooth baseband processor 42 performs a communication by using that at least one frequency band. For example, the resource scheduler 41 can control the wireless LAN baseband processor 43 to output a baseband signal corresponding to the CTS packet and control the RF circuit 44 to convert the baseband signal to an RF signal of the first frequency band.

Further, the resource scheduler 41 can control a period during which the Bluetooth baseband processor 42 transmits voice data, a period during which the Bluetooth baseband processor 42 receives voice data, a period during which the wireless LAN baseband processor 43 transmits voice data, and a period during which the wireless LAN baseband processor 43 receives voice data. For example, embodiments of the resource scheduler 41 can control the above-mentioned periods such that the periods do not conflict with each other while the voice data are transmitted and received in a timely fashion, to thereby enable a voice conversation.

To conduct a reception operation during a period within which the Bluetooth baseband processor 42 is not performing a transmission/reception, the wireless LAN baseband processor 43 can transmit the PS-Poll frame to the AP 11 and receive voice data from the AP 11 when the Bluetooth baseband processor 42 is not performing a transmission/reception. To achieve this selected communication, the wireless LAN baseband processor 43 preferably operates in the power save (PS) mode.

Embodiments of method and systems for transmitting data (e.g., voice) by using the wireless LAN (e.g., first communication type) and the Bluetooth (e.g., second communication type) in accordance with the application have various advantages. For example, a frequency band within a prescribed frequency band used in the Bluetooth communication is different from another frequency band within the prescribed frequency band used in the wireless LAN communication. Further, interference between the communication types or within the frequency range can be reduced or prevented.

Moreover, embodiments of methods and systems for transmitting voice data by using the wireless LAN and the Bluetooth can use a CTS packet broadcasted in a frequency band used in the Bluetooth communication before performing the Bluetooth communication to reduce or prevent the Bluetooth communication from interfering with a wireless LAN communication (e.g., of an adjacent cell).

Further, embodiments of methods and systems for transmitting voice data by using the wireless LAN and the Bluetooth in accordance with the application can perform a voice telephone communication using the headset wirelessly connected with the terminal device by managing resources (e.g., co-operatively) of the wireless LAN and the Bluetooth employing the same frequency band.

Furthermore, embodiments of methods and systems for transmitting voice data by using the wireless LAN and the Bluetooth can use a terminal device to control a reception timing of downlink voice data by using a mode having prescribed communication patterns (e.g., the PS-Poll frame) to reduce transceiving/transceiver conflict or solve problems cased by transmitting the downlink voice data from the AP to the terminal device at any time.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A system, comprising:
a terminal device;
an access point (AP) to transmit voice data or receive voice data from the terminal device according to a wireless LAN protocol; and
a headset to transmit voice data to or receive voice data from the terminal device according to a Bluetooth protocol,
the terminal device to communicate with the AP during a first period, the terminal device to communicate with the headset during a second period that does not coincide with the first period,
the AP to communicate with the terminal device and another terminal device by using a first frequency band among at least three frequency bands of industrial, scientific and medical (ISM) frequency band,
the headset to communicate with the terminal device by using at least one remaining frequency band from the at least three frequency bands.

2. The system of claim 1, wherein the terminal device is configured to broadcast a clear to send (CTS) packet in said at least one remaining frequency band before communicating with the headset.

3. The system of claim 2, wherein the terminal device is configured to operate in a power save (PS) mode.

4. The system of claim 3, wherein the terminal device is configured to periodically perform a transmission/reception with the headset.

5. The system of claim 2, wherein the terminal device receives the voice data from the AP after transmitting a power save poll (PS-Poll) frame to the AP when the terminal device is not communicating with the headset according to the Bluetooth protocol.

6. The system of claim 1, wherein the terminal comprises:
a wireless LAN baseband processor;
a Bluetooth baseband processor coupled to the wireless LAN baseband processor;
an RF circuit coupled to the wireless LAN baseband processor and the Bluetooth baseband processor;
an antenna connected to the RF circuit; and
a resource scheduler to control the RF circuit so that the wireless LAN baseband processor performs a communication by using said first frequency band, and to control the RF circuit so that the Bluetooth baseband processor conducts a communication by using at least a second frequency band or a third frequency band of said at least three frequency bands of the ISM frequency band.

7. The system of claim 6, wherein the wireless LAN baseband processor is configured to operate in a power save (PS) mode.

8. A voice data transmission method in a system including a terminal device, an access point (AP) to communicate with the terminal device according to a wireless LAN protocol, and a headset to communicate with the terminal device according to a Bluetooth protocol, the method comprising:
(a) communicating with the AP by using a first frequency band among three frequency bands of an industrial, scientific and medical (ISM) frequency band by the terminal device;
(b) broadcasting a clear to send (CTS) packet using at least one frequency band of a second frequency band and a third frequency band from said three frequency bands by the terminal device; and
(c) communicating with the headset by using said at least one frequency band by the terminal device.

9. The voice data transmission method of claim 8, comprising repeating communicating with the AP, broadcasting a CTS and communicating with the headset.

10. The voice data transmission method of claim 8, wherein said communicating with the headset comprises receiving voice data from the AP by the terminal device, and wherein the receiving the voice data comprises:
(c1) transmitting a power save poll (PS-Poll) frame to the AP by the terminal device; and
(c2) receiving the voice data that the AP sends to the terminal device in response to the PS-Poll frame by the terminal device.

11. The voice data transmission method of claim 10, further comprising:
making the terminal device enter to a power save (PS) mode prior to said communicating with the AP.

12. The voice data transmission method of claim 10, wherein the terminal device communicates with the headset according to synchronous connection oriented (SCO) high quality voice 2 (HV2), SCO high quality voice 3 (HV3) or extended SCO (eSCO) method.

13. A terminal device comprising:
a wireless LAN baseband processor;
a Bluetooth baseband processor to transmit/receive data to/from the wireless LAN baseband processor;
an RF circuit coupled to the wireless LAN baseband processor and the Bluetooth baseband processor;
an antenna connected to the RF circuit; and
a resource scheduler to control the RF circuit so that the wireless LAN baseband processor performs a communication by using a first frequency band among a plurality of frequency bands of industrial, scientific, and medical (ISM) frequency band, and to control the RF circuit so that the Bluetooth baseband processor conducts a communication by using at least a second frequency band or a third frequency band of said plurality of frequency bands.

14. The terminal device of claim 13, wherein the resource scheduler is configured to control the wireless LAN baseband processor and the RF circuit such that the wireless LAN baseband processor broadcasts a clear to send (CTS) packet in at least said second or third frequency band before the Bluetooth baseband processor performs said communication by using at least said second or third frequency band.

15. The terminal device of claim 14, wherein the resource scheduler controls the Bluetooth baseband processor to periodically perform a transmission and a reception, and controls the wireless LAN baseband processor to perform a transmission and a reception only when the Bluetooth baseband processor does not perform the transmission and the reception.

16. The terminal device of claim 15, wherein the wireless LAN baseband processor transmits a power save poll (PS-Poll) frame to an access point (AP) and receives data from the AP within a period when the Bluetooth baseband processor does not perform the transmission and the reception.

17. The terminal device of claim 16, wherein the wireless LAN baseband processor is configured to operate in a power save (PS) mode.

18. The terminal device of claim 15, wherein the wireless LAN baseband processor is configured to communicate with an access point, and wherein the Bluetooth baseband processor is configured to communicate with a headset according to synchronous connection oriented (SCO) high quality voice 2 (HV2), SCO high quality voice 3 (HV3) or extended SCO (eSCO) method.
